(19) United States
(12) Patent Application Publication
(10) Pub. No.: US 2003/0115284 A1
(43) Pub. Date: Jun. 19, 2003

(54) Method and apparatus for accessing network data associated with a document

(76) Inventor: Steven G. Henry, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/025,043

(22) Filed: Dec. 18, 2001

(51) Int. Cl. G06F 15/16

(52) U.S. Cl. 709/217

(57) ABSTRACT

Apparatus and methods for accessing network data associated with a document are disclosed. According to one embodiment, the method may comprise the steps of converting at least a portion of the document to electronic format with a digital capture input device that is operatively associated with a network, the at least a portion of the document having one or more indicia thereon, analyzing the at least a portion of the document in electronic format to obtain the one or more indicia, using the one or more indicia to locate the network data that is being maintained at another device connected to the network, and accessing the network data.

### FIELD OF INVENTION

The invention relates generally to digital capture input devices, and more specifically, to a method and apparatus for accessing network data associated with a document.

### BACKGROUND

Individuals and businesses both depend on reliable communication with others. As a result, various modes of communication have been developed and continue to be developed and enhanced. For example, mobile telephones are now commonplace for communicating with others regardless of the caller's geography. Also for example, email is becoming an ever increasingly popular method of communicating using personal computers (PCs), and more recently, using stand-alone email appliances. Perhaps one of the main reasons for the increasing popularity of email is the ease at which it allows visual images to be shared. Indeed, relatively inexpensive digital capture input devices, such as digital cameras and scanners, have made it increasingly more convenient to share images via the Internet. Additional modes of communication include, by way of example, facsimile or fax, Internet “web” pages, file transfer protocol (FTP), among others.

Individual devices are available for separate modes of communication. For example, fax machines are available for sending and receiving faxes, and email appliances are available for sending and receiving email. However, some individuals or even businesses may not have access to the devices required for one or more of these communication modes. For example, a businessperson may not have access to a fax machine outside of the office, but may have access to an email account. In addition, purchasing individual devices for each mode of communication may be expensive and space-consuming, which may be particularly burdensome for individuals and small or home-based businesses.

Devices that consolidate various functions are becoming increasingly popular. For example, some photocopiers may also be used as network printers and/or fax machines. Indeed, mobile phones are now available that combine traditional voice communications with Internet and email connectivity. Likewise, a conventional PC may be used for communicating, among other more traditional functions. For example, a conventional PC may be used to send and receive faxes and email, to upload and download files from a network (e.g., the Internet, an Intranet, etc.), and even for voice communications using Internet Protocol (IP) telephony. However, learning to use the software (e.g., fax software, etc.) and the hardware peripherals (e.g., a flatbed scanner, etc.) required to successfully communicate using the PC, may be a daunting task, especially for those unfamiliar with PCs. In addition, purchasing a PC and the necessary software and hardware peripherals may be relatively expensive, especially where only limited use is made of the more traditional functions of the PC (e.g., where it is used primarily for sending and receiving email and faxes, etc.).

Alternatively, multifunction peripherals (MFPs) offer a variety of communication modes from an individual stand-alone device. For example, a multifunction peripheral may include a printer, a scanner, an automatic document feeder (ADF), and a network connection. Although not limited in use, one of the uses to which a MFP may be put is the sharing of visual images over the Internet, which as mentioned earlier is an increasingly popular method of communicating. More specifically, a multifunction peripheral may be used to scan documents and transmit the scanned image of the documents to one of a variety of communication devices including, but not limited to, a fax machine, an email account, another MFP, a printer, a computer (e.g., for storage, viewing, editing, etc.), or a handheld device such as a mobile phone or personal digital assistant (PDA), etc.

In addition to MFPs, digital senders may also be used to share visual images via the Internet. The typical digital sender includes a scanner, an ADF, and a network connection. As before with the MFPs, digital senders are capable of scanning documents and then transmitting the scanned image of the documents to one of a variety of communication devices including, but not limited to, a fax machine, an email account, another MFP, a printer, a computer (e.g., for storage, viewing, editing, etc.), or a handheld device such as a mobile phone or personal digital assistant (PDA), etc.

Digital senders and multifunction peripherals are especially useful in home offices or field offices. For example, closing agents typically close real estate transactions for title companies at various field offices. The closing agent may need to send a copy of a document to the main office of the title company for approval before completing the transaction. As such, the closing agent may position the document or documents in the ADF, or directly on the scanning bed of the digital sender or MFP, as the case may be. With a few steps (e.g., entering the recipient's fax number, etc.), the document is scanned and transmitted to the fax machine at the main office. Or for example, where the title company officer whose approval is required only has access to an email account, the multifunction device or digital sender may instead send the scanned image of the document to the title company officer's email account.

As just explained, individuals and businesses both depend on reliable communication with others. However, in addition to depending on reliable communication with others, many individuals and businesses must also depend on advertising to facilitate the sale of their products. For example, a business may resort to rather lengthy ads to ensure that a consumer receives enough product information (e.g., price, options, warranties, purchase incentives, purchase order forms, etc.) allowing the consumer to make an informed decision on whether to purchase the advertised product. Such an approach, however, can be rather costly because the cost of an ad is often directly proportional to the size or length of the ad. Moreover, because it may be difficult, if not impossible, to accurately determine beforehand which consumer group will be interested in a product, many business must resort to flooding the market with their product advertisements. Consequently, significant amounts of time and money may be expended or wasted on advertising to uninterested consumers.

### SUMMARY OF THE INVENTION

Methods for accessing network data associated with a document are disclosed. According to one embodiment, the method may comprise the steps of converting at least a portion of the document to electronic format with a digital capture input device that is operatively associated with a network, the at least a portion of the document having one or more indicia thereon, analyzing the at least a portion of the document in electronic format to obtain the one or more indicia, using the one or more indicia to locate the network data that is being maintained at another device connected to the network, and accessing the network data.

Also disclosed are apparatus and systems for accessing network data associated with a document. According to one embodiment, at least a portion of the document may have one or more indicia thereon and may be converted to electronic format with a digital capture input device operatively associated with a network. One or more computer readable storage media having computer readable program code stored thereon may be provided. The computer readable program code may comprise program code for analyzing the at least a portion of the document in electronic format to obtain the one or more indicia, and program code for using the one or more indicia to locate the network data that is being maintained at another device connected to the network. The computer readable program code may further comprise program code for accessing the network data.

### BRIEF DESCRIPTION OF THE DRAWING

Illustrative and presently preferred embodiments of the invention are shown in the accompanying drawing in which:

FIG. 1 is a high level diagram illustrating an embodiment of a system that may be used for accessing network data associated with a document; and

FIG. 2 is a flow chart illustrating an embodiment of a method that may be used to access network data associated with a document.

### DETAILED DESCRIPTION OF THE INVENTION

An apparatus 10 and a method 12 for accessing network data 14 (e.g., information, specifications, options, coupons, purchase order forms, purchase incentives, company information, warranties, etc.) associated with a document 16 (e.g., advertisements, newspaper article, magazine article, etc.) are shown and described herein as they could be used with a digital capture input device 18. Briefly, the present invention generally comprises converting at least a portion 17 of the document 16 having one or more indicia 20 thereon (e.g., document's 16 content, text, characters, character shapes, pictures, patterns, one or more words, combinations of letters orwords, signs, logos, symbols, etc.) to electronic format 16′ with the digital capture input device 18, analyzing the electronic document 16′ to obtain the one or more indicia 20, and using the one or more indicia 20 to locate the network data 14 which may later be accessed (e.g., retrieved, displayed, printed out, etc.) by a user (not shown).

One advantage that may be realized by an embodiment of the invention is that it may allow users to obtain additional information (e.g., price, options, specifications, coupons, purchase order forms, purchase incentives, company information, warranties, etc.) about a document (e.g., advertisement, newspaper article, magazine article, etc.) for which they have an interest. By providing this feature, the present invention may allow advertisers to reduce the size of and thus the costs associated with their ads. Because the present invention may allow an interested consumer to obtain additional information related to or associated with an advertisement, only that information deemed necessary need be provided in the advertisement. In addition, the present invention may also allow an advertiser to ensure a precise hit or retrieval of network data associated with an ad. As explained in greater detail below, an advertiser may provide an ad with very specific and detailed indicia or tags (e.g., machine-readable data, bar code label, UPC label, reference number, symbol, etc.) and thus ensure that an interested consumer will be provided with the exact and specific network data associated with the one or more tags provided in the ad.

Another advantage that may be realized by an embodiment of the invention is that it may allow advertisers to determine who is interested in their ads and to evaluate their ads. For example, advertisers may track their ads to determine which of their ads are generating further inquiries and requests for more information and which are not.

Yet another advantage that may be provided by an embodiment of the present invention is the realization of proprietary or monetary gains. For example, an advertiser may be charged a fee (e.g., a click fee) each time network data associated with or related to that advertiser's product or ad is provided to a user.

Having generally described the apparatus 10 and method 12 for accessing network data related to a document, as well as some of their features and advantages, various embodiments of the apparatus 10 and method 12 will now be described in detail.

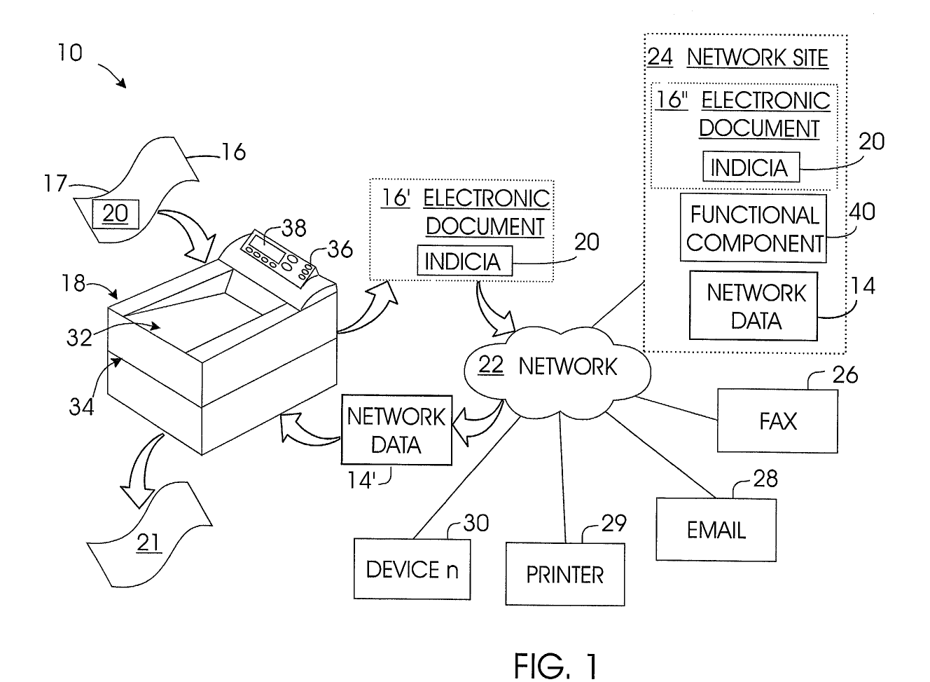

FIG. 1 is a high level diagram illustrating the components of one embodiment of the apparatus or system 10 that may be used for accessing the network data 14 associated with the document 16. It is understood that although the invention is preferably for use with the Internet, the invention is not limited strictly for use with the Internet. That is, the network 22 may be any suitable network (e.g., a local area network (LAN), a wide area network (WAN), an Intranet, the Internet, a combination thereof, etc.). Likewise, any number (i.e., one or more) of network destinations and devices may be operatively associated with or linked to the network 22 (e.g., digital capture input device 18, network site or Internet web page 24, facsimile machine 26, email address or account 28, printer 29, device 30, a personal computer(PC), a copier, a personal digital assistant (PDA), etc.) via any suitable means (e.g., modem, T-1, T-3, digital subscriber line (DSL), infrared, satellite, cable, etc.), including through yet other devices (e.g., routers, hubs, etc.), through yet other networks (e.g., LAN, WAN, Intranet, the Internet, etc.), etc.

To convert the paper document 16 having the one or more indicia 20 thereon to electronic format 16′ and to transmit the electronic document 16′ over the network 22 to one of a variety of network destinations 24-30, the digital capture input device 18 may be used. For example, the digital capture input device 18 may comprise a multifunction peripheral or a digital sender, either of which may be used as follows to send a paper document 16 across the network 22. First, a user may position the paper document 16 in an automatic document feeder (ADF) 32 or directly on a scanning bed 34 of the digital capture input device 18. The user may then activate the digital capture input device 18, for example, by pressing a scan key (e.g., 36). As a result, the digital capture input device 18 may scan the paper document 16. The user may then identify a recipient or network destination for the scanned image of the paper document 16. For example, the user may identify the network site 24 by keying in the web address or uniform resource locator (URL) for the network site 24 using the keypad 36 or by selecting the network site 24 from a menu shown on a display panel 38. Finally, the digital capture input device 18 may then send the electronic document 16′ via the network 22 to the recipient previously identified or selected by the user.

It is understood that the term “paper document” as used herein is intended to encompass any document (e.g., photocopies, printed paper, photographs, slides, transparencies, viewgraphs, color documents, black/white documents, etc.) or portion thereof (e.g., document portion 17 containing the one or more indicia 20, etc.) that may be imaged by the digital capture input device 18. In addition, more than one paper document 16 may be converted to one or more electronic documents 16′. For example, a stack of paper documents 16 may be scanned using the ADF 30, or the user may individually scan a plurality of paper documents 16 using the scanning bed 32. In any event, the scanned images may be combined or individually included with one or more electronic documents 16′. Moreover, the document 16 is not limited to any particular physical size (e.g., 8½″×11″, etc.). For example, if the document 16 is too large to allow the digital capture input device 18 to readily convert the document 16 in its entirety to electronic format 16′ (e.g., the document 16 is too large to fit entirely into the ADF 32 or fit entirely onto the scanning bed 34, etc.), a user may instead opt to scan the document portion 17 on which the one or more indicia 20 are located rather than scanning the entire document 16. From this point forward in the description, however, it will be assumed that the document 16 is sized such that the digital capture input device 18 may readily convert the document 16 to electronic format 16′ in its entirety. Consequently, the remainder of the description will be directed to the digital capture input device 18 converting the entire document 16, not just the document portion 17, to electronic format 16′, although the present invention is not so limited.

In one embodiment, the digital capture input device 18 comprises an HP® 9100C Digital Sender™, currently available from Hewlett-Packard® Company, Palo Alto, Calif. The HP® 9100C Digital Sender™ is capable of scanning documents and then converting the documents to electronic format, such as Portable Document Format (PDF) and Tagged Image File Format (TIFF). The HP® 9100C is enabled for sending electronic documents to email accounts, fax machines, to PCs (e.g., for viewing or editing with suitable software applications), to HP® JetSend®-enabled devices, to applications, and to network printers. In another embodiment, the digital capture input device 18 may comprise a multifunction peripheral (MFP), such as the HP® OfficeJet® G95 currently available from Hewlett-Packard® Company, Palo Alto, Calif. The HP® OfficeJet® G95 is capable of printing, copying, faxing, and scanning, and thus may be used to print the at least a portion 21 of the network data 14′. However, it is understood that any suitable digital capture input device, now known or later developed, may be used according to the teachings of the embodiments of the invention. Indeed, it is understood that in other embodiments, the digital capture input device may be a multifunction device, a multifunction peripheral, a digital sender, a network digital copier, an “all-in-one” device for attachment to a PC, a network-capable scanner, a digital camera, etc. Accordingly, the present invention should not be regarded as limited to use in conjunction with the digital capture input device 18 shown and described herein.

It is understood that the digital capture input device 18 may send documents to any suitable receiving device, and is not limited to those shown and described herein. In addition, while the digital capture input device 18 is preferably enabled for connection to a Transmission Control Protocol/Internet Protocol (TCP/IP) network 22, the digital capture input device 18 may be connected over any suitable network or networks, including but not limited to, a local area network (LAN), a wide area network (WAN), a secure network, an Intranet, the Internet, etc. Likewise, the digital capture input device 18 may be connected to the network 22 in any suitable manner, including but not limited to, a hardwired connection, an infrared connection, a dial-up connection (i.e., using a modem), a dedicated connection (e.g., cable, digital subscriber line (DSL), T-1, T-3, etc.), via BLUETOOTH™, via satellite, through yet other devices (e.g., routers, hubs, etc.), through other networks (e.g., LAN, WAN, Intranet, the Internet, etc.), through a combination of networks, etc.

Moreover, although FIG. 1 shows the digital capture input device 18 being directly connected to the network 22 (i.e., with no intermediary devices between the digital capture input device 18 and the network 22), such need not be the case. For example, in an alternative embodiment (not shown), the digital capture input device 18 may be linked to the network 22 via one or more intermediary devices, such as a personal computer.

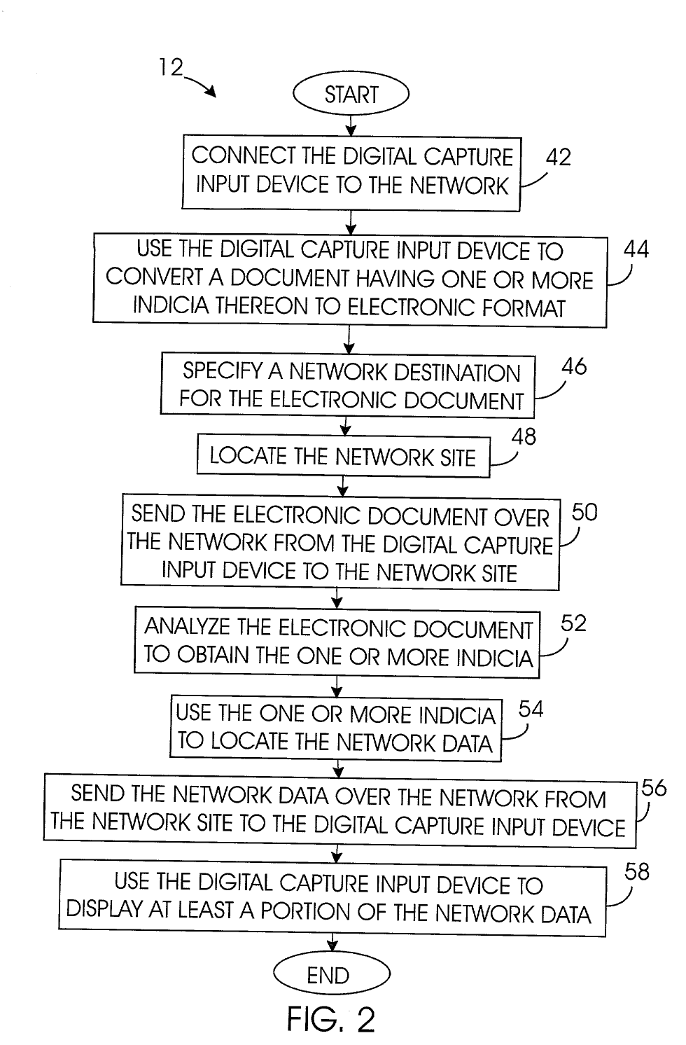

The apparatus 10 may be provided with a functional component 40 to carry out the various functional aspects of the invention. Preferably, the functional component 40 may be embodied in hardware, firmware and/or software (i.e., hardware and/or computer readable program code). For example, in one embodiment, the functional component 40 may comprise computer readable program code and the necessary hardware for executing the same. The computer readable program code may be stored in one or more suitable computer readable storage media operatively associated with the network 22. For example, the computer readable program code comprising the functional component 40 may be stored in one or more computer readable storage media residing at, or associated with, the network site 24. Alternatively, the computer readable program code comprising the functional component 40 may be stored in one or more computer readable storage media residing at, or associated with, the digital capture input device 18, elsewhere on the network 22, a combination thereof, etc. The computer readable program code may also reside within a “hard wired” box or stand-alone device (not shown) that is operatively associated with the network 22. Regardless of where it resides, however, the computer readable program code may comprise program code for carrying out one or more of the various steps of the method 12 shown in FIG. 2 with such steps being performed automatically (i.e., without any user intervention), manually by a user, or in some combination thereof.

As explained in greater detail below, the manner in which a user accesses the network data 14 may vary. Likewise, the format of the network data 14 may also vary. Preferably, however, the network data 14 is formatted so that it may be viewed with readily available software (e.g., ADOBE® READER® available from Adobe Systems Incorporated, San Jose, Calif., etc.) or converted for output at a readily available device (e.g., digital capture input device 18, fax machine 26, printer 29, a photocopier, etc.).

According to one embodiment, the apparatus 10 may be operated in accordance with the method 12 shown in FIG. 2. In the first step 42, the digital capture input device 18 may be connected to the network 22, if it is not already so connected. As described in detail earlier, the digital capture input device 18 is preferably enabled for connection to a Transmission Control Protocol/Internet Protocol (TCP/IP) network 22. However, the digital capture input device 18 may also be connected to any suitable network or networks at step 42 via any suitable manner. Moreover, the digital capture input device 18 may be directly linked to the network 22 (FIG. 1) or linked to the network 22 via one or more intermediary devices (not shown).

In step 44, the document 16 having the one or more indicia 20 thereon may be acquired in electronic format 16′. More specifically, in one embodiment, step 44 may comprise using the digital capture input device 18 to scan the document 16 and to convert the document 16 to electronic format 16′. Alternatively, and as explained earlier, only the document portion 17 having the one or more indicia 20 thereon may be converted to electronic format 16′ at step 44.

In step 46, the network site 24 to which the electronic document 16′ is to be sent may be selected automatically (i.e., without any user intervention), manually by a user (e.g., by accessing keypad 36 or display 38), in a combination thereof, etc. In the next step 48, the network site 24 may be located on the network 22 so that the digital capture input device 18 and the network site 24 may communicate with each other.

After the network site 24 has been located, the electronic document 16′ may then be sent at step 50 over the network 22 from the digital capture input device 18 to the network site 24. Preferably, the network site 24 is always or permanently linked to the network 22. Otherwise, the network data 14 associated with a document 16 may not be accessible to a user when the network site 24 is not linked to the network 22.

At step 52, the functional component 40 may analyze the electronic document 16″ to obtain the one or more indicia 20. The process used by the functional component 40 to obtain the one or more indicia 20 may depend, at least in part, upon what the one or more indicia 20 comprises (e.g., signs, symbols, characters, character shapes, reference numbers, pictures, patterns, one or more words, combinations of words or letters, etc.).

In one embodiment, the one or more indicia 20 may comprise a portion of the content (text, logos, line art, graphics, data, etc.) of the document 16. For example, the one or more indicia 20 may comprise at least one character or one or more words. In such an embodiment, the functional component 40 may use pattern or character recognition in conjunction with optical character recognition to obtain the one or more indicia 20 from the electronic document 16″.

Before continuing with the description, it should be noted that pattern recognition generally refers to the ability of a device to identify patterns, such as visual images or sound patterns that have been converted to arrays of numbers. Whereas, character recognition generally refers to the process of applying pattern-matching methods to character shapes that have been read into a device to determine which alphanumeric characters or punctuation marks the shapes represent. Finally, optical character recognition is the process in which a device examines printed characters on paper and determines their shapes by detecting patterns of dark and light. Once the shapes have been determined, character recognition may then be used to translate the shapes into computer text. With the aforementioned processes, however, different typefaces and text treatments (e.g., bold, italic, etc.) can alter the way characters are shaped and thus decrease the accuracy level of character recognition systems. Thus, it is generally preferred, but not required, that the one or more indicia 20 be tailored for the particular recognition system being used to obtain the one or more indicia 20. For example, if the particular recognition system being used by the functional component 40 only works with certain typefaces and sizes and with no text treatments, then the one or more indicia 20 should not have any text treatment and should be in a typeface and size that is recognizable by that recognition system. However, because pattern recognition, character recognition, and optical character recognition are all well-known in the art and could be easily provided by persons having ordinary skill in the art after having become familiar with the teachings of the present invention, they will not be described in further detail herein.

Continuing now with the description, once the one or more indicia 20 have been obtained at step 52, the one or more indicia 20 may be used at step 54 to locate the network data 14 maintained at the network site 24. More specifically, the one or more indicia 20 may comprise one or more words (e.g., the text of document 16, etc.) that are obtained (step 52) by the functional component 40 via character recognition. If so, the functional component 40 may perform the following steps to locate the network data 14 maintained at the network site 24. First, the functional component 40 may determine a frequency for each of the one or more words comprising indicia 20. Next, the functional component 40 may compare the frequencies of the one or more words of indicia 20 to a word frequency list. The functional component 40 may then use the results of the frequency comparison to locate the network data 14. More specifically, the functional component 40 may use the word frequency list to determine which of the one or more words of indicia 20 has a frequency that exceeds its expected frequency by the greatest amount. The functional component 40 may then locate the network data 14 associated with that particular word. For example, if the functional component 40 determines that the word “zebra” has a frequency exceeding its expected frequency by the largest amount, the functional component 40 may locate the network data 14 associated with “zebra.” When the indicia 20 comprise the text of the document 16, using the aforementioned process may allow the topic of the document 16 to be acquired or discovered because the topic may coincide with the word of indicia 20 or, in this case the word of the document text, that has a frequency exceeding its expected frequency by the greatest amount. Word-frequency lists and the process of using the same are well-known in the art and could be easily provided by persons having ordinary skill in the art after having become familiar with the teachings of the present invention. Thus, the particular word-frequency list utilized in one embodiment of the invention will not be described in detail herein.

Assuming now that the network data 14 has been located, the network data 14 may be accessed at steps 56 and 58. More specifically, in one embodiment, the network data 14′ may be sent over the network 22 from the network site 24 to the digital capture input device 18 (step 56) so that the digital capture input device 18 may display the at least a portion 21 of the network data 14′ (step 58). For example, the at least a portion 21 of the network data 14′ may be displayed on the display panel 38 of the digital capture input device 18 at step 58. Or for example, the digital capture input device 18 may comprise a multifunction peripheral that prints out the at least a portion 21 of the network data 14′ at step 58. The digital capture input device 18 may also send the network data 14′ to another device (e.g., fax machine 26, email account 28, printer 29, network device 30, etc.) which may be used to display or print out the at least a portion 21 of the network data 14′ at step 58. In another embodiment, the network data 14′ may instead be sent over the network 22 from the network site 24 directly to another network device (e.g., fax machine 26, email account 28, printer 29, network device 30, etc.) or email account which may be used to display or print out the at least a portion 21 of the network data 14′ at step 58. Alternatively, any of a wide range of other suitable methods may also be used to access the network data 14 as would be obvious to persons having ordinary skill in the art after having become familiar with the teachings of the present invention.

It should be noted that the network data 14′ may be received in its entirety before any portion thereof is displayed. Alternatively, the network data 14′ may instead be received and displayed piecemeal or in portions. For example, the digital capture input device 18 may receive and display the at least a portion 21 of the network data 14′ at step 58 before the digital capture input device 18 receives and displays any further portion of the network data 14′.

It should also be noted that the steps comprising method 12 are preferably performed automatically (i.e., without any user intervention) and transparently to the user. That is, in one embodiment, the user preferably only needs to position the document 16 in the ADF 30 or directly on the scanning bed 32, and then activate the digital capture input device 18. The digital capture input device 18 then should convert the document 16 to electronic format 16′ and send the electronic document 16′ over the network 22 to the network site 24. Upon receipt thereof, the network site 24 should analyze the electronic document 16″ to obtain the one or more indicia 20, use the one or more indicia 20 to locate the network data 14, and then send the network data 24 over the network 22 to the digital capture input device 18. In response thereto, the digital capture input device 18 should then display the at least a portion 21 of the network data 14 in one of the manners previously described.

It is understood that FIG. 2, as is FIG. 1, is merely exemplary of the invention and is not intended to limit the scope thereof. In other embodiments, additional steps may be included in method 12 with such steps being performed automatically, manually, or in some combination thereof based on the configuration of the apparatus 10. For example, the method 12 may further comprise storing the network data 14′ in one or more computer readable storage media operatively associated with the digital capture input device 18. By doing so, the digital capture input device 18 may continue to display or otherwise allow access to the network data 14′ even if the digital capture input device 18 has been disconnected from the network 22.

As mentioned earlier, an advertiser may want to ensure a precise hit or retrieval of network data 14 associated with an ad. If so, the advertiser may provide the document 16 with very specific and detailed indicia or tags (not shown). Thus, the method 12 may further comprise the step of providing the document 16 with one or more tags. In such an embodiment, step 52 may then comprise analyzing the electronic document 16″ to obtain the one or more tags, and step 54 may comprise using the one or more tags to locate the network data 14.

The one or more tags that may be provided on the document 16 may comprise any of a wide range of types and formats including, but not limited to, bar code labels, UPC labels, signs, symbols, characters, character shapes, reference numbers, pictures, patterns, one or more words, combinations of words, etc. For example, in one embodiment, the one or more tags provided to the document 16 may comprise machine-readable data. More specifically, the document 16 may be provided with a bar code label comprising bars thereon that are representative of a label data set. If so, the functional component 40 may comprise a bar code reading or data processing system that may be used to obtain the label data set from the electronic document 16″. After obtaining the label data set, the functional component may then locate (step 54) the network data 14 associated with the label data set represented by the bars of the bar code label. Because bar code reading systems are well-known in the art and could be easily provided by persons having ordinary skill in the art after having become familiar with the teachings of the present invention, the particular bar code reading system utilized in one embodiment of the invention will not be described in detail herein.

In another embodiment, the one or more tags may comprise one or more numbers, such as a reference number or telephone number. In such an embodiment, the functional component 40 may use pattern or character recognition in conjunction with optical character recognition to obtain the reference number from the electronic document 16″ at step 52. In the next step 54, the functional component 40 may then locate the network data 14 associated with the particular reference number.

Regardless of the type of tag used, it is generally preferred, but not required, that the format of the one or more tags aid in the process used to analyze the electronic document 16″ and obtain the one or more tags (step 52). Stated differently, the format of the one or more tags should allow the functional component 40 to readily identify the one or more tags as such. For example, in one embodiment, the one or more tags may comprise a bar code label that is provided with a rectangular border that allow the functional component 40 to readily identify the bar code label as the one or more tags.

As noted earlier, a user may have more than one option available to access the network data 14. If so, the method 12 may further comprise the step of allowing a user to select the manner in which the network data 14 will be accessed. For example, the user may be able to select from having the at least a portion 21 of the network data 14′ displayed on the display panel 38 of digital capture input device 18, printed out by the printer 29, sent to the fax machine 26, sent to the email account 28, etc.

It is to be understood that the computer readable program code described herein can be conventionally programmed using any of a wide range of suitable computer readable programming languages that are now known in the art or that may be developed in the future. It is also to be understood that the computer readable program code can include one or more functions, routines, subfunctions, and subroutines, and need not be combined in a single package but may instead be embodied in separate components. In addition, the program code can reside within the digital capture input device 18 or it can have one or more components that reside at one or more locations on the network 22.

Although it is envisioned that the invention disclosed herein will be implemented in software or firmware code, such need not be the case. That is, the invention may be implemented through hardware, firmware, etc., or a combination thereof.

What is claimed is:

1. A method for accessing network data associated with a document, comprising:
converting at least a portion of said document to electronic format with a digital capture input device, the at least a portion of said document having one or more indicia thereon, the digital capture input device being operatively associated with a network;
analyzing the at least a portion of said document in electronic format to obtain said one or more indicia;
using said one or more indicia to locate said network data, said network data being maintained at another device operatively associated with the network; and
accessing said network data.

2. The method of claim 1, wherein said one or more indicia comprises at least a portion of the text on the at least a portion of said document.

3. The method of claim 1, further comprising:
providing the at least a portion of said document with one or more tags before the at least a portion of said document is converted to electronic format with said digital capture input device;
analyzing the at least a portion of said document in electronic format to obtain said one or more tags; and
using said one or more tags to locate said network data.

4. The method of claim 3, wherein said one or more tags comprise machine-readable data.

5. The method of claim 1, wherein accessing said network data comprises receiving said network data at said digital capture input device.

6. The method of claim 5, further comprising displaying at least a portion of said network data on display apparatus operatively associated with said digital capture input device.

7. The method of claim 5, further comprising printing at least a portion of said network data on printer apparatus operatively associated with said digital capture input device.

8. The method of claim 1, wherein accessing said network data comprises receiving said network data at an email account.

9. The method of claim 1, wherein accessing said network data comprises receiving said network data at a network device.

10. The method of claim 1, wherein accessing said network data comprises displaying at least a portion of said network data.

11. The method of claim 1, further comprising sending the at least a portion of said document in electronic format from said digital capture input device to said another device.

12. The method of claim 1, wherein analyzing the at least a portion of said document in electronic format to obtain said one or more indicia comprises using character recognition to obtain said one or more indicia.

13. The method of claim 1, wherein said one or more indicia comprises one or more words, and wherein using said one or more indicia to locate said network data comprises:
determining a frequency for each of said one or more words;
comparing the frequencies of said one or more words with a word frequency list; and
using the results of said frequency comparison to locate said network data.

14. The method of claim 1, wherein said digital capture input device is a multifunction device.

15. Apparatus for accessing network data associated with a document, comprising:
one or more computer readable storage media; and
computer readable program code stored on said one or more computer readable storage media, said computer readable program code comprising:
program code for analyzing at least a portion of said document to obtain one or more indicia from the at least a portion of said document after the at least a portion of said document has been converted to electronic format with a digital capture input device operatively associated with a network;
program code for using said one or more indicia to locate said network data, said network data being maintained at another device operatively associated with the network; and
program code for accessing said network data.

16. The apparatus of claim 15, wherein said digital capture input device is a multifunction device.

17. The apparatus of claim 15, wherein said one or more indicia comprises at least a portion of the text on the at least a portion of said document.

18. The apparatus of claim 15, further comprising one or more tags provided on the at least a portion of said document; and wherein said computer readable program code further comprises:
program code for analyzing the at least a portion of said document in electronic format to obtain said one or more tags; and
program code for using said one or more tags to locate said network data.

19. The apparatus of claim 18, wherein said one or more tags comprise machine-readable data.

20. The apparatus of claim 15, wherein said program code for accessing said network data comprises program code for receiving said network data at said digital capture input device.

21. The apparatus of claim 20, wherein said computer readable program code further comprises program code for displaying at least a portion of said network data on display apparatus operatively associated with said digital capture input device.

22. The apparatus of claim 20, wherein said computer readable program code further comprises program code for printing at least a portion of said network data on printer apparatus operatively associated with said digital capture input device.

23. The apparatus of claim 15, wherein said program code for accessing said network data comprises program code for sending said network data to an email account.

24. The apparatus of claim 15, wherein said program code for accessing said network data comprises program code for sending said network data to a network device.

25. The apparatus of claim 15, wherein said program code for accessing said network data comprises program code for displaying at least a portion of said network data.

26. The apparatus of claim 15, wherein said computer readable program code further comprises program code for sending the at least a portion of said document in electronic format from said digital input capture device to said another device.

27. The apparatus of claim 15, wherein said program code for analyzing the at least a portion of said document in electronic format to obtain said one or more indicia comprises program code for using character recognition to obtain said one or more indicia.

28. The apparatus of claim 15, wherein said one or more indicia comprises one or more words, and wherein said program code for using said one or more indicia to locate said network data comprises:
program code for determining a frequency for each of said one or more words;
program code for comparing the frequencies of said one or more words with a word frequency list; and
program code for using the results of said frequency comparison to locate said network data.

29. A system for accessing network data associated with a document, comprising:
a digital capture input device operatively associated with a network, said digital capture input device converting at least a portion of said document to electronic format, the at least a portion of said document having one or more indicia thereon;
one or more computer readable storage media;
computer readable program code stored on said one or more computer readable storage media, said computer readable program code comprising:
program code for analyzing the at least a portion of said document in electronic format to obtain said one or more indicia;
program code for using said one or more indicia to locate said network data, said network data being maintained at another device operatively associated with the network; and
program code for receiving said network data at said digital capture input device.

30. The system of claim 29, wherein said digital capture input device is a multifunction device.

31. The system of claim 29, wherein said one or more indicia comprises at least a portion of the text on the at least a portion of said document.

32. The system of claim 29, further comprising one or more tags provided on the at least a portion of said document; and wherein said computer readable program code further comprises:
program code for analyzing the at least a portion of said document in electronic format to obtain said one or more tags; and
program code for using said one or more tags to locate said network data.

33. The system of claim 32, wherein said one or more tags comprise machine-readable data.

34. Apparatus for accessing network data associated with a document, comprising:
means for converting at least a portion of said document to electronic format, said means being operatively associated with a network, the at least a portion of said document having means for locating said network data;
means for analyzing the at least a portion of said document in electronic format to obtain said means for locating said network data;
means for using said means for locating said network data to locate said network data, said network data being maintained at another device connected to the network; and
means for accessing said network data.
